(19) United States
(12) Patent Application Publication
(10) Pub. No.: US 2010/0308020 A1
(43) Pub. Date: Dec. 9, 2010

(54) ELECTRICAL SOLDERING IRON

(75) Inventors: JUN-WEI ZHANG, Shenzhen City (CN); JUN ZHANG, Shenzhen City (CN); WEI LIU, Shenzhen City (CN); REN-WEN HUANG, Shenzhen City (CN); JI-XIANG YIN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/629,885

(22) Filed: Dec. 3, 2009

(30) Foreign Application Priority Data
Jun. 3, 2009 (CN) 200910302873.7

(51) Int. Cl. B23K 3/03

(52) U.S. Cl. 219/85.16

(57) ABSTRACT

An electrical soldering iron is provided. The soldering iron comprises a heating element, a constant temperature heating circuit, a motion sensor, and a processor. The constant temperature heating circuit is configured for heating the heating element. The motion sensor is configured for detecting motion of the electrical soldering iron. The processor is configured for determining motion state of the electrical soldering iron according to signals from the motion sensor and directing the constant temperature heating circuit to bring the heating element to a temperature of a predetermined value corresponding to the motion state.

### BACKGROUND

1. Technical Field

The present disclosure relates to electrical soldering, and more particularly, to an electrical soldering iron capable of assuming lower temperatures during work interruption.

2. Description of Related Art

Electrical soldering irons are known in the art. One type of soldering iron includes a heating element used to heat the tip of the soldering iron. When power is applied to the soldering iron, the temperature of the heating element continues to increase. If soldering work is interrupted, the soldering iron is supported by a dedicated stand. However, even during the work interruption, the tip of the soldering iron maintains a high soldering temperature, which accelerates oxidation of the tip material and reduces lifetime of the soldering iron.

Therefore, what is needed is a soldering iron that is capable of assuming a lower temperature during work interruption.

### BRIEF DESCRIPTION OF THE DRAWINGS

The components in the drawings are not necessarily drawn to scale, the emphasis instead being placed upon clearly illustrating the principles of the electrical soldering iron. Moreover, in the drawings, like reference numerals designate corresponding parts throughout the several views.

FIG. 1 is a block diagram of an electrical soldering iron in accordance with an exemplary embodiment.

FIG. 2 shows a relational table stored in a processor of the electrical soldering iron of FIG. 1.

FIG. 3 is a block diagram of an electrical soldering iron in accordance with another exemplary embodiment.

FIG. 4 shows a relational table stored in a processor of the electrical soldering iron of FIG. 3.

### DETAILED DESCRIPTION

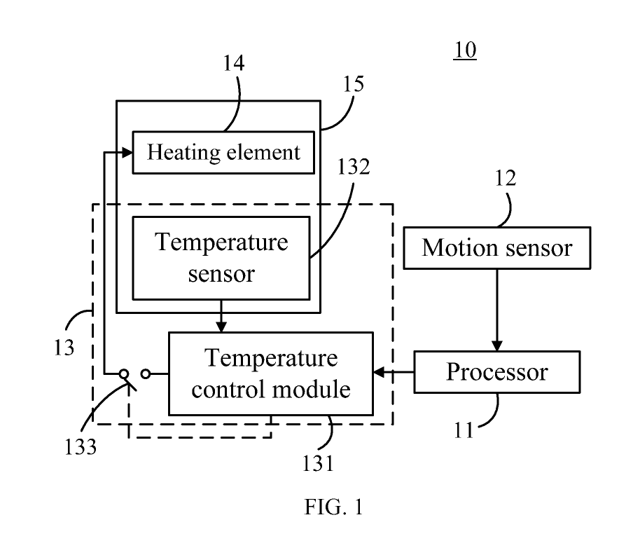

Referring to FIG. 1, in an exemplary embodiment, an electrical soldering iron 10 includes a processor 11, a motion sensor 12, a constant temperature heating circuit 13, a heating element 14, and a soldering iron tip 15 which includes the heating element 14.

The motion sensor 12 is coupled to the processor 11 and detects motion of the soldering iron 10. In the exemplary embodiment, the motion sensor 12 is an acceleration sensor. During soldering work, the motion sensor 12 continues outputting voltage signals, which correspond to the acceleration values of the soldering iron 10.

The processor 11 determines a motion state of the soldering iron 10 according to the voltage signals from the motion sensor 12. For example, during the soldering work interruption, the soldering iron 10 is supported by a stand and the acceleration value of the soldering iron 10 falls to zero. A work interruption state is determined when the acceleration value of the soldering iron 10 remains at zero for a predetermined time period. Other motion states are determined when the soldering iron 10 experiences motion at varying levels of velocity and displacement.

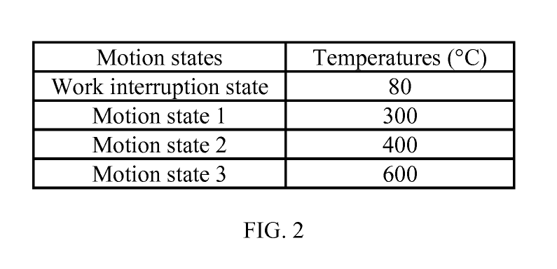

Referring to FIG. 2, the motion states of the soldering iron 10 are correlated with the temperature of the soldering iron tip 15. The relationship between the motion state and the temperature of the soldering iron tip 15 are defined in a relational table stored in the processor 11.

Upon determining the motion state of the soldering iron 10, the processor 11 directs the constant temperature heating circuit 13 to bring the heating element 14 to a predetermined temperature corresponding to the motion state. For example, after power has been applied to the soldering iron 10, movement of the soldering iron 10 causes the processor 11 to determine the motion state and direct the constant temperature heating circuit 13 to bring the heating element 14 to a temperature of a predetermined value corresponding to the motion state. As mentioned, adjustment of the heating element 14 can be achieved by motion of the soldering iron 10. In the present embodiment, the heating element 14 includes iron chrome alloy or Nichrome.

Similarly, when determining the soldering iron 10 is in a work interruption state, the processor 11 directs the constant temperature heating circuit 13 to bring the heating element 14 to a (here reduced) temperature of a predetermined value corresponding to the work interruption state.

The constant temperature heating circuit 13 includes a temperature control module 131, a temperature sensor 132, and a changeover switch 133. The temperature control module 131 is coupled to the temperature sensor 132 via the changeover switch 133. The temperature sensor 132 and the heating element 14 are incorporated within the tip 15. The temperature sensor 132 can be any suitable device providing accurate detection of temperature characteristics in all temperature ranges and is linear in the resistance change. A ceramic temperature sensor may be used.

The temperature control module 131 regulates the temperature of the heating element 14. The temperature control module 131 may include a known operational amplifier, a heater drive unit, and other elements, not shown. The output voltages from the temperature sensor 132 and the processor 11 are introduced to the operational amplifier. The operational amplifier delivers the difference between these voltages to the heater drive unit to control the temperature of the heating element 14, which is accordingly maintained at a constant temperature, as is, commensurately, tip 15.

In the exemplary embodiment, the changeover switch 133 is a triac. The action signal from the heater drive unit is introduced to the gate of the triac. The changeover switch 133 is turned on or off depending on the output level of the action signal, so that current to the heating element 14 is controlled.

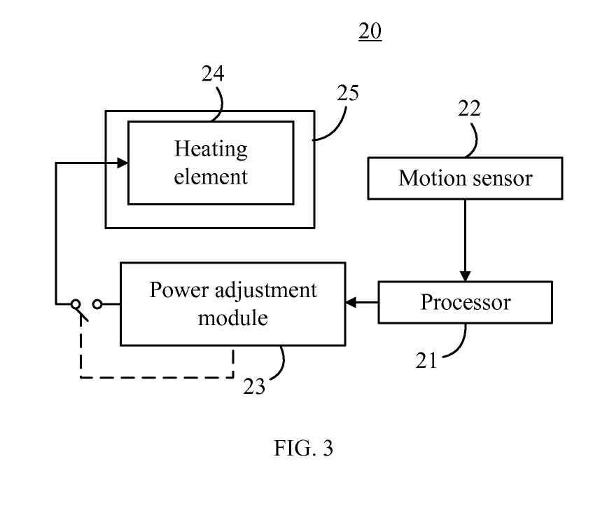

Referring to FIG. 3, in another embodiment, a soldering iron 20 includes a processor 21, a motion sensor 22, a power adjustment module 23, a heating element 24, and a soldering iron tip 25. Similarly, the motion sensor 22 is coupled to the processor 21 and detects motion of the soldering iron 20. In the exemplary embodiment, the motion sensor 22 is an acceleration sensor. During work, the motion sensor 22 continuously outputs voltage signals corresponding to the acceleration values of the soldering iron 20.

The processor 21 determines a motion state of the soldering iron 20 according to the voltage signals from the motion sensor 22. For example, a work interruption state is determined when the acceleration value of the soldering iron 20 remains at zero for a predetermined time period. Other motion states are determined by movement of the soldering iron 20 generating different levels of acceleration.

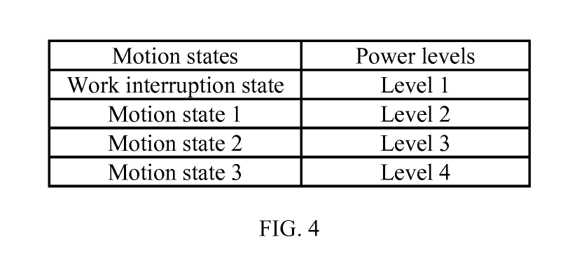

Referring to FIG. 4, the motion states of the soldering iron 20 are correlated with the temperature of the soldering iron tip 25. The relationship between the motion state and the temperature of the soldering iron tip 25 are defined in a relational table stored in the processor 11.

The power adjustment module 23 is regulates power applied to the heating element 24. Upon determining the motion state of the soldering iron 20, the processor 21 directs the power adjustment module 23 to apply a predetermined level of power corresponding to the motion state to the heating element 24. For example, after power has been applied to the soldering iron 20, a positive acceleration value measured in the soldering iron 20 is interpreted as a working state, in response to which processor 21 directs power adjustment module 23 to apply a predetermined power level corresponding to the motion state to the heating element 24.

Similarly, when determining the soldering iron 20 is in a work interruption state, the processor 21 directs the power adjustment module 23 to apply a predetermined power level corresponding to the work interruption state (here, lowered) to the heating element 24.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An electrical soldering iron comprising:
a heating element;
a constant temperature heating circuit regulating temperature of the heating element;
a motion sensor detecting movement of the electrical soldering iron and generating output signals accordingly; and
a processor determining motion state of the electrical soldering iron according to the signals from the motion sensor and directing the constant temperature heating circuit to adjust temperature of the heating element to a predetermined value corresponding to the motion state.

2. The electrical soldering iron according to claim 1, wherein the motion sensor is an acceleration sensor.

3. The electrical soldering iron according to claim 1, wherein the heating element comprises iron chrome alloy.

4. The electrical soldering iron according to claim 1, wherein the heating element comprises Nichrome.

5. The electrical soldering iron according to claim 1, wherein the processor comprises a relational table defining the relationship between the motion state and temperature of the heating element.

6. The electrical soldering iron according to claim 1, wherein the constant temperature heating circuit comprises a temperature control module, a temperature sensor, and a changeover switch.

7. The electrical soldering iron according to claim 6, wherein the changeover switch comprises a triac.

8. An electrical soldering iron comprising:
a heating element;
a power adjustment module for adjusting power applied to the heating element;
a motion sensor for detecting movement of the electrical soldering iron and generating output signals accordingly; and
a processor determining motion state of the electrical soldering iron according to the signals from the motion sensor and directing the power adjustment module to adjust the power level of the heating element to a predetermined value corresponding to the motion state.

9. The electrical soldering iron according to claim 8, wherein the motion sensor is an acceleration sensor.

10. The electrical soldering iron according to claim 8, wherein the heating element comprises iron chrome alloy.

11. The electrical soldering iron according to claim 8, wherein the heating element comprises Nichrome.

12. The electrical soldering iron according to claim 8, wherein the processor comprises a relational table defining the relationship between the motion state and the power applied to the heating element.
